(19) United States
(12) Patent Application Publication
(10) Pub. No.: US 2005/0065050 A1
(43) Pub. Date: Mar. 24, 2005

(54) Selective silicon etch chemistries, methods of production and uses thereof

(76) Inventor: John S. Starzynski, Plymouth, MN (US)

Correspondence Address: Sandra P. Thompson;Bingham McCutchen, LLP, 18th Floor, 600 Anton Blvd., Costa Mesa, CA, 92626, US

(21) Appl. No.: 10/827,011

(22) Filed: Apr. 19, 2004

Related U.S. Application Data
(60) Provisional application No. 60/505,269, filed on Sep. 23, 2003.

(51) Int. Cl. C11D 1/00

(52) U.S. Cl. 510/175

(57) ABSTRACT

Silicon etchants described herein are aqueous solutions that comprise at least one of potassium hydroxide or tetramethyl ammonium hydroxide; at least one additive, wherein the additive comprises at least two of the following physical properties: water-soluble, non-volatile and non-flammable; and an aqueous environment that comprises at least one solvent or solvent blend. Methods of producing a selective silicon etchant include: a) providing at least one of potassium hydroxide or tetramethyl ammonium hydroxide; b) providing at least one additive, wherein the additive comprises at least two of the following physical properties: water-soluble, non-volatile and non-flammable; c) providing an aqueous environment that comprises at least one solvent or solvent blend; and d) blending the at least one potassium hydroxide or tetramethyl ammonium hydroxide with the at least one additive in the aqueous environment in order to form a solution that can be utilized as a selective silicon etchant.

This application claims priority to U.S. Provisional Application Ser. No.: 60/505269 filed in Sep. 23, 2003, which is commonly-owned and incorporated herein in its entirety.

### FIELD OF THE SUBJECT MATTER

The field of the subject matter is selective etch chemistries and cleaning chemistries for semiconductor, electronic and related applications.

### BACKGROUND

The technique of bulk silicon removal by means of a selective chemical etching is a key step in the manufacture of many types of MEMS (microelectromechanical systems) devices. Selective chemical etching, as its name suggests, is an etching process that is designed to be selective to a particular surface and/or material.

A “p-type” material is a material utilized in semiconductor applications where the material has free-holes created by a specific dopant. A “p++” type material is a p-type material that is highly doped with boron, wherein the material has a resistivity between 0.0005 Ω·cm and 0.010 Ω·cm, such as a silicon wafer with a p⁺⁺ doped (highly boron-doped ˜10²⁰/cm³) implanted, diffused or epitaxial layer that is several microns thick. In order to produce efficient and relatively defect-free semiconductor materials that contain these p++ type of materials, it is important to remove that material that is not p++ type material, whether it is material that was otherwise contaminated or not formed properly with respect to the other material.

Wafers and layered semiconductor materials are generally etched in the epitaxial layer employing a hard mask and either dry or non-selective wet etch techniques. The undoped (or lightly doped) portion of the wafer is “lost” by dissolving it in a chemical etchant that is selective to the p⁺⁺ silicon, leaving behind the structures in the p⁺⁺ doped silicon layer. A silicon etchant with undoped Si to p⁺⁺ doped Si etch selectivity of at least 500 is needed for the “lost wafer” process. The selectivity of any solution is a function of the doping concentration raised to the fourth power. For example, doubling the dopant concentration will increase the etch selectivity by a factor of 16.

Etchants containing varying amounts of ethylenediamine, pyrocatechol, and water (EDP) have been found to have the highest p⁺⁺ etch selectivity, which is approximately 1000 for a boron doping level of 1×10²⁰/cm³. In these types of etching solutions, the relative amounts of ethylenediamine, pyrocatechol, and water in EDP can be changed to enhance some etch characteristics. For example, the silicon etch rate can be increased by decreasing the ethylenediamine concentration. However, one of the significant disadvantages of EDP is that it is highly toxic, potentially carcinogenic, and difficult to dispose of in an environmentally friendly manner. In addition, EDP vapors are notorious for corroding metal ventilation ducting. Another disadvantage is that EDP's etch rate and selectivity is also a strong function of the dissolved silicon in the solution (the Silicon Loading Effect). Because of loading, only one 4-inch surface per 0.75 liters of EDP can be processed. This kind of selective etch is a redox reaction:
The silicon is oxidized: Si+4OH⁻→Si(OH)₄+4e⁻
and water is reduced: 4H₂O+4e⁻→4OH⁻+2H₂

In an effort to combat the disadvantages of utilizing EDP as an etching solution, solutions containing hydroxide ions (OH⁻) and water molecules (in other words, aqueous bases) were developed and shown to etch silicon and show some p⁺⁺ selectivity; however, the selectivity of these solutions is not sufficient to be utilized in most p++ etching applications.

The most widely used EDP alternatives are aqueous solutions containing 10-50 weight percent of potassium hydroxide (KOH). These etchants are much safer to handle and easier to dispose. The Si₃N₄ etch selectivity is high (>>1000) and similar to EDP, but the low temperature deposited oxides (LTO), such as silicon dioxide, etch selectivity is more than an order of magnitude lower than that of EDP. In addition, p⁺⁺ etch selectivity of these solutions is less than half that of EDP. The p⁺⁺ etch selectivity of KOH solutions can be improved by the addition of isopropyl alcohol (IPA). But IPA has a very high vapor pressure at the operating temperature (usually between 70° C. and 95° C.). As the alcohol evaporates, the selectivity decreases. In addition, IPA vapors are fire and explosion hazards.

Therefore, it would be desirable to form a selective etching solution that has at least one of the following characteristics: a) a high p⁺⁺ etch selectivity; b) a high etch selectivity to films that can be used as hard masks such as low temperature oxide (LTO), or silicon nitride (Si₃N₄); c) a silicon etch rate >0.5 μm/minute; d) a relatively low vapor pressure at the operating temperature; as well as e) ease of handling and disposal.

### SUMMARY OF THE SUBJECT MATTER

Silicon etchants described herein are aqueous solutions that comprise at least one of potassium hydroxide or tetramethyl ammonium hydroxide; at least one additive, wherein the additive comprises at least two of the following physical properties: water-soluble, non-volatile and non-flammable; and an aqueous environment that comprises at least one solvent or solvent blend.

A method of producing a selective silicon etchant includes: a) providing at least one of potassium hydroxide or tetramethyl ammonium hydroxide; b) providing at least one additive, wherein the additive comprises at least two of the following physical properties: water-soluble, non-volatile and non-flammable; c) providing an aqueous environment that comprises at least one solvent or solvent blend; and d) blending the at least one potassium hydroxide or tetramethyl ammonium hydroxide with the at least one additive in the aqueous environment in order to form a solution that can be utilized as a selective silicon etchant.

### BRIEF DESCRIPTION OF THE FIGURES & TABLES

FIG. 1 shows relative etch rates and selectivities of conventional and contemplated etching solutions.

FIG. 2 shows relative silicon etch rate as a function of KOH and additive concentration in P-Plus-K contemplated embodiments.

FIG. 3 shows a contour plot of the undoped Si to p⁺⁺ Si etch selectivity as a function of KOH and ethylene glycol concentration.

FIG. 4 shows a response surface plot of the undoped Si to p⁺⁺ Si etch selectivity as a function of KOH and ethylene glycol concentration.

FIG. 5 shows a graph of undoped to doped silicon etch selectivity as a function of temperature for 15 weight percent of KOH and 37 weight percent of ethylene glycol.

FIG. 6 shows the surface of an undoped silicon etch rate plot with a high held factor setting.

FIG. 7 shows the surface of an undoped silicon etch rate plot with a low held factor setting.

FIG. 8 shows the surface of a CVD oxide etch rate plot with a mid held factor setting.

FIG. 9 shows the contour of a CVD oxide etch rate plot with a mid held factor setting.

FIG. 10 shows the surface of a thermal oxide etch rate plot with a mid held factor setting.

FIG. 11 shows the contour of a thermal oxide etch rate plot with a mid held factor setting.

FIG. 12 shows relative silicon etch rate as a function of TMAH and additive concentration in P-Plus-T contemplated embodiments.

Table 1 shows factors utilized for several contemplated embodiments in a Box-Behnken design experiment.

### DETAILED DESCRIPTION

A class of safer selective silicon etchants and etch chemistries to etch silicon in situations that require high p⁺⁺ selectivity such as the “lost wafer” process have been developed and are disclosed herein. These selective etching solutions have at least one of the following characteristics: a) a relatively high p⁺⁺ etch selectivity as compared to EDP etching solutions; b) a high etch selectivity to films that can be used as hard masks such as low temperature oxide (LTO), or silicon nitride (Si₃N₄); c) a silicon etch rate >0.5 μm/minute; d) a relatively low vapor pressure at the operating temperature; and e) ease of handling and disposal.

Silicon etchants described herein are aqueous solutions that comprise at least one of potassium hydroxide or tetramethyl ammonium hydroxide; at least one additive, wherein the additive comprises at least two of the following physical properties: water-soluble, non-volatile and non-flammable; and an aqueous environment that comprises at least one solvent or solvent blend. In some contemplated embodiments, these etchants comprise water-soluble, nonvolatile and nonflammable additives. Contemplated additives are organic bases, (TMAH, TEAH), alkali metal bases (KOH, LiOH, NaOH, RbOH and CsOH), alkaline earth metal bases (Ca(OH)₂, Ba(OH)₂, Sr(OH)₂,), hydroxyl solvents and those compounds and compositions that comprise glycol and glycol-based derivatives, such as glycerol, glyceride, glycerine, alkylene glycols (ethylene glycol, propylene glycol).

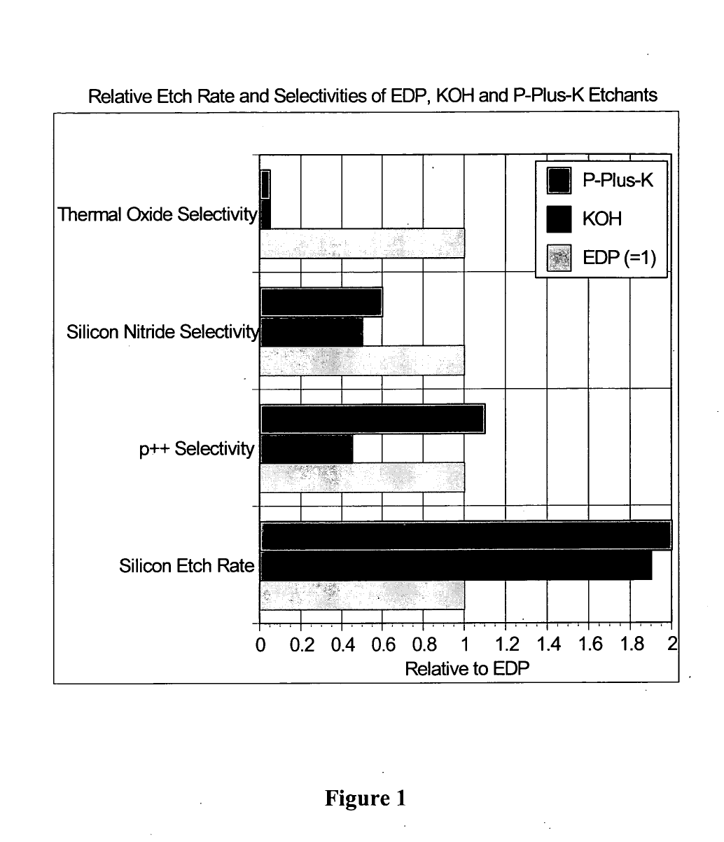

In contemplated embodiments, these chemistries have p⁺⁺ selectivity equal to that of EDP but are much safer to handle and dispose. The etch rates and selectivities of other films such as SiO₂ and Si₃N₄ are similar to those of KOH or KOH with IPA solutions. The undoped silicon etch rate, p⁺⁺ etch selectivity, sputtered silicon nitride etch selectivity, and thermal oxide etch selectivity of KOH and P-Plus-K relative to EDP are presented in FIG. 1. These values are approximate and will vary with specific formulations, as well as, process temperature. As used herein, the terms “P-Plus-K” and “P-PLUS2™” can be used interchangeably and mean an etching solution that comprises at least one of potassium hydroxide or tetramethyl ammonium hydroxide; at least one additive, wherein the additive comprises at least two of the following physical properties: water-soluble, non-volatile and non-flammable; and an aqueous environment that comprises at least one solvent or solvent blend.

Like EDP and KOH etchants, the P-Plus-K etchants can be custom blended for specific applications; however, it is contemplated that the process of custom blending does not require undue experimentation once the disclosure herein, including the stated goals, is understood by one of ordinary skill in the art of etching chemistries for electronic and semiconductor applications.

In another contemplated embodiment, including those that require CMOS compatibility or higher oxide selectivities, the P-Plus-T family of etchants can be produced and utilized. As used herein, the terms “P-Plus-T” and “P-PLUS 1™” may be used interchangeably and mean those aqueous solutions that comprise TMAH; at least one additive, wherein the additive comprises at least two of the following characteristics: water-soluble, non-volatile and non-flammable; and an aqueous environment that comprises at least one solvent or solvent blend. This chemistry has higher p⁺⁺ selectivity than standard TMAH etchants, but not as high as P-Plus-K. The etch rates and selectivities of other films such as SiO₂ and Si₃N₄ are similar to those of standard TMAH solutions. As with P-Plus-K etchants, the P-Plus-T etchants can be custom blended for specific applications.

In contemplated embodiments, the potassium hydroxide and/or tetramethyl ammonium hydroxide may be added in an amount less than about 30 weight percent in solution. In other contemplated embodiments, the potassium hydroxide and/or tetramethyl ammonium hydroxide may be added in an amount less than about 20 weight percent in solution. In yet other contemplated embodiments, the potassium hydroxide and/or tetramethyl ammonium hydroxide may be added in an amount less than about 10 weight percent in solution.

In contemplated embodiments, the at least one additive may be added in an amount less than about 75 weight percent in solution. In other contemplated embodiments, the at least one additive may be added in an amount less than about 60 weight percent in solution. In yet other contemplated embodiments, the at least one additive may be added in an amount less than about 50 weight percent in solution. And in still other contemplated embodiments, the at least one additive may be added in an amount less than about 30 weight percent in solution.

The etching solutions described herein comprise an aqueous environment that comprises at least one solvent or solvent blend. As used herein, the term “environment” means that environment in the solution containing the at least one of potassium hydroxide or tetramethyl ammonium hydroxide; at least one additive, wherein the additive comprises at least two of the following physical properties: water-soluble, non-volatile and non-flammable; and the at least one solvent or solvent blend. The term “environment” does not mean the environment surrounding the solution, such as the environment present in the lab or in the building. For example, an aqueous environment means that the solution is aqueous and does not refer to the overall humidity level of the air in the lab or building.

Contemplated solvents include any suitable pure or mixture of organic molecules that are volatilized at a desired temperature, such as the critical temperature, or that can facilitate any of the above-mentioned design goals or needs. The solvent may also comprise any suitable pure or mixture of polar and non-polar compounds, as long as the environment is aqueous. As used herein, the term “pure” means that component that has a constant composition. For example, pure water is composed solely of H₂O. As used herein, the term “mixture” means that component that is not pure, including salt water. As used herein, the term “polar” means that characteristic of a molecule or compound that creates a substantial unequal charge, partial charge or spontaneous charge distribution at one point of or along the molecule or compound. As used herein, the term “non-polar” means that characteristic of a molecule or compound that creates a substantially equal charge, partial charge or spontaneous charge distribution at one point of or along the molecule or compound. It should be understood that those compounds included under the definition of “non-polar” are those compounds that are both clearly non-polar or slightly polar. One of ordinary skill in the art of chemistry and etching solutions will know which solvents are non-polar/slightly polar and which solvents are clearly polar in nature.

It is also contemplated that the solvents used herein may comprise any suitable impurity level, such as less than about 1 ppm, less than about 100 ppb, less than about 10 ppb and in some cases, less than about 1 ppb. These solvents may be purchased having impurity levels that are appropriate for use in these contemplated applications or may need to be further purified to remove additional impurities and to reach the less than about 10 ppb and less than about 1 ppb levels that are becoming more desirable in the art of etching.

In some contemplated embodiments, the solvent or solvent mixture (comprising at least two solvents) comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosine, isobutylbenzene, methylnaphthalene, ethyltoluene, ligroine. Particularly contemplated solvents include, but are not limited to, pentane, hexane, heptane, cyclohexane, benzene, toluene, xylene and mixtures or combinations thereof

In other contemplated embodiments, the solvent or solvent mixture may comprise those solvents that are not considered part of the hydrocarbon solvent family of compounds, such as ketones, such as acetone, diethyl ketone, methyl ethyl ketone and the like, alcohols, esters, carbonate-based compounds, such as propylene carbonate and the like, water, ethers and amines. In yet other contemplated embodiments, the solvent or solvent mixture may comprise a combination of any of the solvents mentioned herein.

Methods and uses of these safer and selective etch chemistries are also contemplated herein. Such methods include providing the constituents of the selective etch chemistry formulation, blending the constituents to form the formulation and applying the formulation to a surface or substrate. In some embodiments, the formulation may be produced in situ (directly on the surface) or may be formed before application to the surface.

One contemplated method of producing a selective silicon etchant includes: a) providing at least one of potassium hydroxide or tetramethyl ammonium hydroxide; b) providing at least one additive, wherein the additive comprises at least two of the following physical properties: water-soluble, non-volatile and non-flammable; c) providing an aqueous environment that comprises at least one solvent or solvent blend; and d) blending the at least one potassium hydroxide or tetramethyl ammonium hydroxide with the at least one additive in the aqueous environment in order to form a solution that can be utilized as a selective silicon etchant that comprises at least one of the following characteristics: a) a relatively high p⁺⁺ etch selectivity as compared to EDP etching solutions; b) a high etch selectivity to films that can be used as hard masks such as low temperature oxide (LTO), or silicon nitride (Si₃N₄); c) a silicon etch rate >0.5 μm/minute; d) a relatively low vapor pressure at the operating temperature; and e) ease of handling and disposal.

In some contemplated etchants and methods, the selective silicon etchant may be held or utilized at a certain temperature. Contemplated temperatures for selective silicon etchants may be less than about 125° C. Other contemplated temperatures for selective silicon etchants may be less than about 105° C. Yet other contemplated temperatures for selective silicon etchants may be less than about 95° C. And in some embodiments, the contemplated temperature for selective silicon etchants may be less than about 85° C. The effects of certain temperatures are shown in the Examples section.

Any or all of the chemicals and compounds described herein may be provided by a) purchasing the chemicals and/or compounds from a company or university that produces the chemicals and/or compounds; b) synthesizing the chemicals and/or compounds in house; c) a combination thereof.

Contemplated selective silicon etchants, such as those described herein, may be applied to any suitable surface. Surfaces contemplated herein may comprise any desirable substantially solid material, such as a substrate, wafer or other suitable surface that comprises at least in part a p⁺⁺ doped implanted, diffused or epitaxial layer. Surface and/or substrate layers comprise at least one layer and in some instances comprise a plurality of layers. In preferred embodiments, the substrate comprises a silicon, gallium arsenide or germanium-silicon die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers such as polyimide. In more preferred embodiments, the substrate comprises a material common in the integrated circuit industries as well as the packaging and circuit board industries such as silicon, copper, glass, and another polymer. Suitable surfaces contemplated herein may also include another previously formed layered stack, other layered component, or other component altogether. An example of this may be where a dielectric material and CVD barrier layer are first laid down as a layered stack—which is considered the “surface” for the subsequently spun-on layered component.

At least one layer may be coupled to the surface or substrate. As used herein, the term “coupled” means that the surface and layer or two layers are physically attached to one another or there's a physical attraction between two parts of matter or components, including bond forces such as covalent and ionic bonding, and non-bond forces such as Van der Waals, electrostatic, coulombic, hydrogen bonding and/or magnetic attraction. Also, as used herein, the term coupled is meant to encompass a situation where the surface and layer or two layers are directly attached to one another, but the term is also meant to encompass the situation where the surface and the layer or plurality of layers are coupled to one another indirectly—such as the case where there's an adhesion promoter layer between the surface and layer or where there's another layer altogether between the surface and layer or plurality of layers.

As used herein, the term “low dielectric constant” means a dielectric constant measured at 1 MHz to 2 GHz, unless otherwise inconsistent with context. It is contemplated that the value of the dielectric constant of a low dielectric constant material or layer is less than about 3. In a preferred embodiment, the value of a low dielectric constant material or layer is less than about 2.5. In a more preferred embodiment, the value of a dielectric constant material or layer is less than about 2.

Contemplated dielectric and low dielectric materials comprise inorganic-based compounds, such as silicon-based disclosed in commonly assigned U.S. Pat. No. 6,143,855 and pending U.S. Ser. No. 10/078919 filed Feb. 19, 2002; (for example Honeywell NANOGLASS® and HOSP® products), gallium-based, germanium-based, arsenic-based, boron-based compounds or combinations thereof, and organic-based compounds, such as polyethers, polyarylene ethers disclosed in commonly assigned U.S. Pat. No. 6,124,421 (such as Honeywell FLARE™ product), polyimides, polyesters and adamantane-based or cage-based compounds disclosed in commonly assigned WO 01/78110 and WO 01/08308 (such as Honeywell GX-3™ product). The dielectric and low dielectric materials may be applied by spin coating the material on to the surface, dip coating, spray coating, rolling the material on to the surface, dripping the material on to the surface, and/or spreading the material on to the surface.

The wafer, substrate and/or surface may be dipped into the etching solution once and held for a particular time period or dipped multiple times, may be rinsed by the solution, may have the solution applied in a methodical patterned form, may be masked and then rinsed by the solution, etc. In contemplated embodiments where the wafer or substrate is dipped into solution and held for a particular time period, the time period is greater than, about 5 minutes. In some contemplated embodiments where the wafer or substrate is dipped into solution and held for a particular time period, the time period is greater than about 10 minutes. In other contemplated embodiments where the wafer or substrate is dipped into solution and held for a particular time period, the time period is greater than about 15 minutes. In yet other contemplated embodiments where the wafer or substrate is dipped into solution and held for a particular time period, the time period is greater than about 20 minutes.

The selective etching solution may also be held at a particular temperature which optimizes the etching and/or cleaning abilities of the solution or may be varied with respect to temperature depending on the wafer or surface to be cleaned. The term “varied” is used herein with respect to temperature to mean that the solution temperature may be varied while the wafer is being processed or may be varied from wafer to wafer depending on the extent of residue that needs to be etched or removed.

The substrates, wafers and surfaces described herein, once etched by the solutions disclosed herein, may be used alone or in combination with other layers to form a substrate, a layered component, a semiconductor component or an electronic component.

Electronic-based products can be “finished” in the sense that they are ready to be used in industry or by other consumers. Examples of finished consumer products are a television, a computer, a cell phone, a pager, a palm-type organizer, a portable radio, a car stereo, and a remote control. Also contemplated are “intermediate” products such as circuit boards, chip packaging, and keyboards that are potentially utilized in finished products.

Electronic products may also comprise a prototype component, at any stage of development from conceptual model to final scale-up/mock-up. A prototype may or may not contain all of the actual components intended in a finished product, and a prototype may have some components that are constructed out of composite material in order to negate their initial effects on other components while being initially tested.

As used herein, the term “felectronic component” means any device or part that can be used in a circuit to obtain some desired electrical action. Electronic components contemplated herein may be classified in many different ways, including classification into active components and passive components. Active components are electronic components capable of some dynamic function, such as amplification, oscillation, or signal control, which usually requires a power source for its operation. Examples are bipolar transistors, field-effect transistors, and integrated circuits. Passive components are electronic components that are static in operation, i.e., are ordinarily incapable of amplification or oscillation, and usually require no power for their characteristic operation. Examples are conventional resistors, capacitors, inductors, diodes, rectifiers and fuses.

Electronic components contemplated herein may also be classified as conductors, semiconductors, or insulators. Here, conductors are components that allow charge carriers (such as electrons) to move with ease among atoms as in an electric current. Examples of conductor components are circuit traces and vias comprising metals. Insulators are components where the function is substantially related to the ability of a material to be extremely resistant to conduction of current, such as a material employed to electrically separate other components, while semiconductors are components having a function that is substantially related to the ability of a material to conduct current with a natural resistivity between conductors and insulators. Examples of semiconductor components are transistors, diodes, some lasers, rectifiers, thyristors and photosensors.

Electronic components contemplated herein may also be classified as power sources or power consumers. Power source components are typically used to power other components, and include batteries, capacitors, coils, and fuel cells. As used herein, the term “battery” means a device that produces usable amounts of electrical power through chemical reactions. Similarly, rechargeable or secondary batteries are devices that store usable amounts of electrical energy through chemical reactions. Power consuming components include resistors, transistors, ICs, sensors, and the like.

Still further, electronic components contemplated herein may also be classified as discreet or integrated. Discreet components are devices that offer one particular electrical property concentrated at one place in a circuit. Examples are resistors, capacitors, diodes, and transistors. Integrated components are combinations of components that that can provide multiple electrical properties at one place in a circuit. Examples are ICs, i.e., integrated circuits in which multiple components and connecting traces are combined to perform multiple or complex functions such as logic.

### EXAMPLES

P-Plus-K Experiments

Design of experiment (DOE) studies were conducted to determine etch rates and selectivities as a function of KOH and additive concentration as well as temperature. A response surface Box-Behnken design with high, medium and low settings of each of three factors was used. The factors utilized were temperature, ethylene glycol concentration and KOH concentration. A 3-factor Box-Behnken response surface design with 3 center points consists of a total of 15 experiments. Table 1 below shows the factors utilized and their values:

| Factor | High | Middle | Low |
|---|---|---|---|
| 45% KOH Concentration (v/0) | 17 | 14 | 11 |
| Ethylene Glycol | 50 | 40 | 30 |
| Concentration (v/0) | | | |
| Temperature (° C.) | 105 | 95 | 85 |

Etch rates and etch selectivities of p⁺⁺ doped silicon, undoped silicon, thermally grown silicon dioxide (TOx), low temperature deposited silicon dioxide (LTO) as well as sputtered silicon nitride (Si₃N₄) films as a function of KOH concentration, ethylene glycol concentration, and temperature were measured employing design of experiment (DOE) methodology. As a result of these experiments, the following equation was developed for undoped/doped silicon etch selectivity as a function of KOH concentration, ethylene glycol concentration and temperature:
F(K,E,T)=−19067.7+362.049K+54.9298E+332.694T+−12.0305K²+−0.741112E²+−1.73388T²
Where:
F(K,E,T)=Undoped/Doped Si Etch Selectivity
K=KOH concentration (v/0)
E=Ethylene Glycol concentration (v/0)
T=Temperature (° C.)

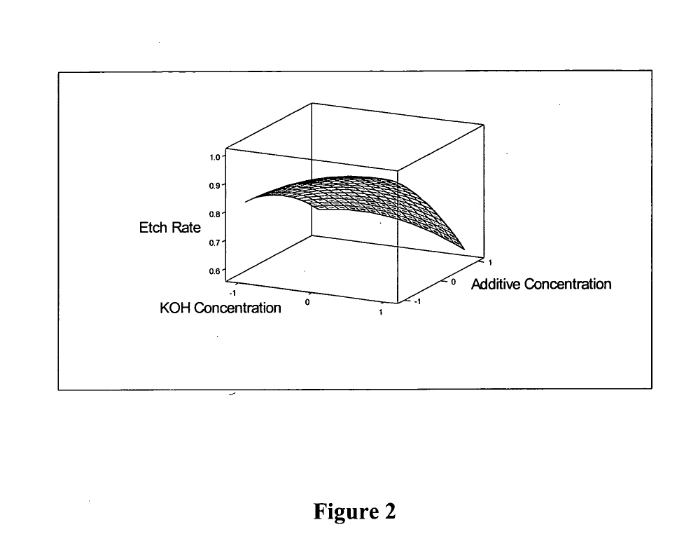

The relative etch rate of undoped silicon as a function of KOH and additive concentration, presented in FIG. 2, is an example of the DOE results.

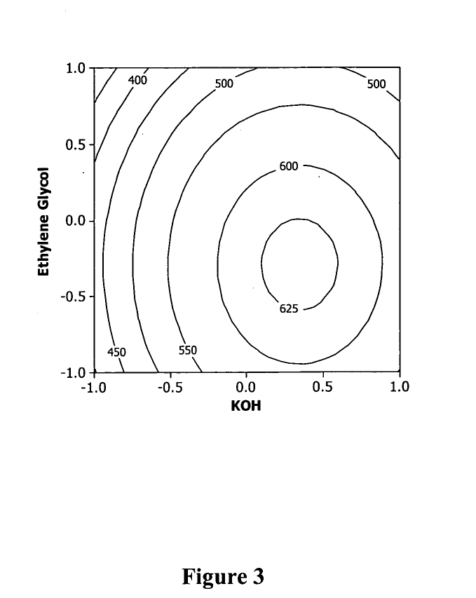

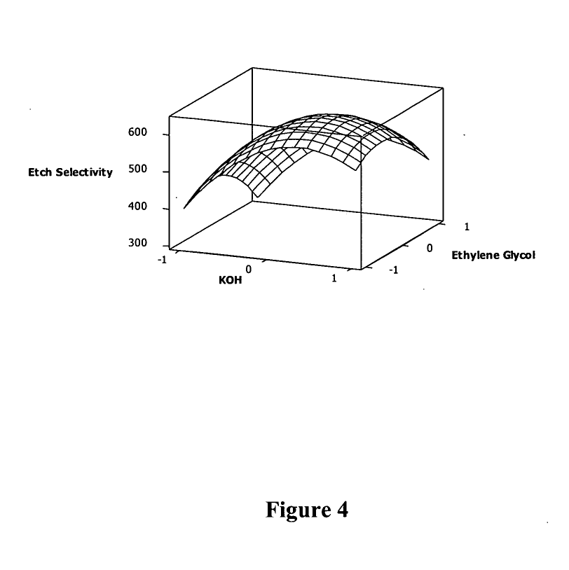

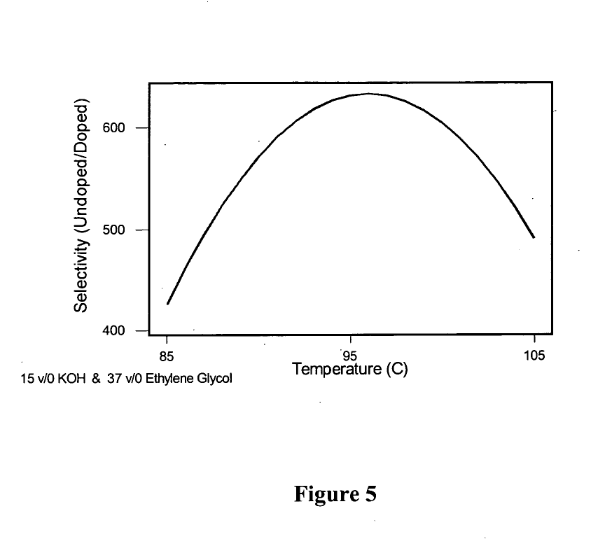

The addition of ethylene glycol to aqueous KOH solutions dramatically increases the undoped Si to p⁺⁺ doped Si etch selectivity. This etch selectivity is approximately 100 for KOH-water solutions. The undoped Si to p⁺⁺ doped Si etch selectivity of KOH-ethylene glycol-water solutions can approach 1000. A contour plot of the undoped Si to p⁺⁺ doped Si etch selectivity as a function of KOH and ethylene glycol concentration is presented in FIG. 3. A response surface plot of the undoped Si to p⁺⁺ doped Si etch selectivity as a function of KOH and ethylene glycol concentration is presented in FIG. 4. FIG. 5 shows a graph of undoped to doped silicon etch selectivity as a function of temperature for 15 weight percent of KOH and 37 weight percent of ethylene glycol.

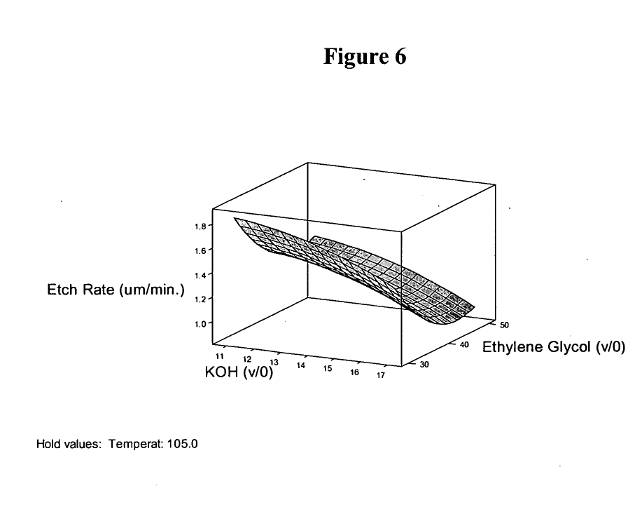

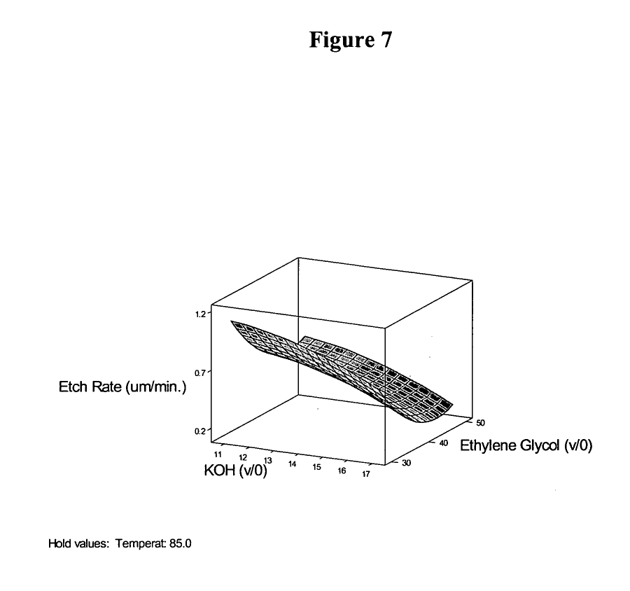

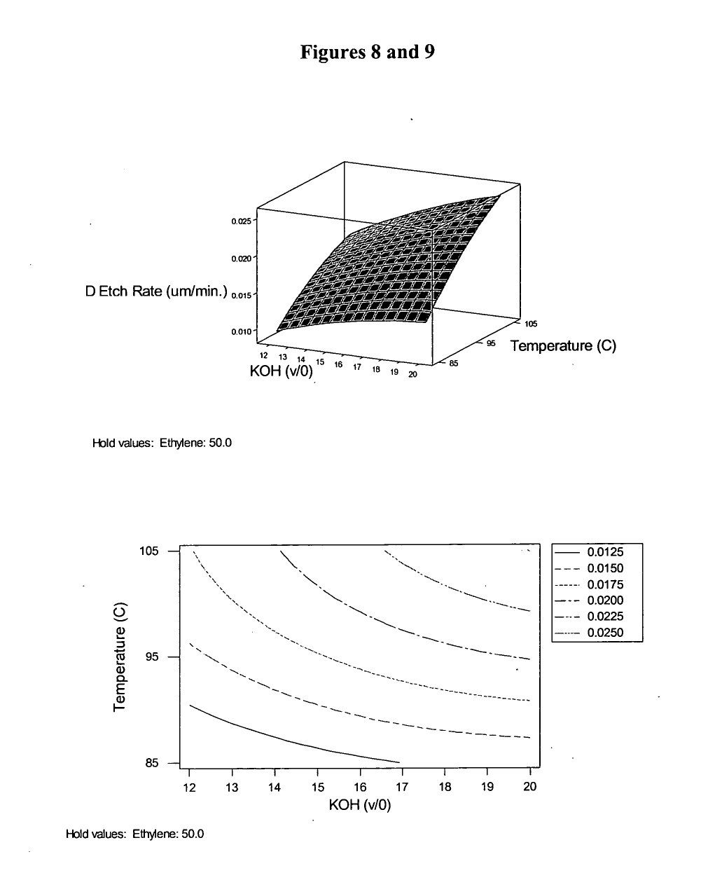

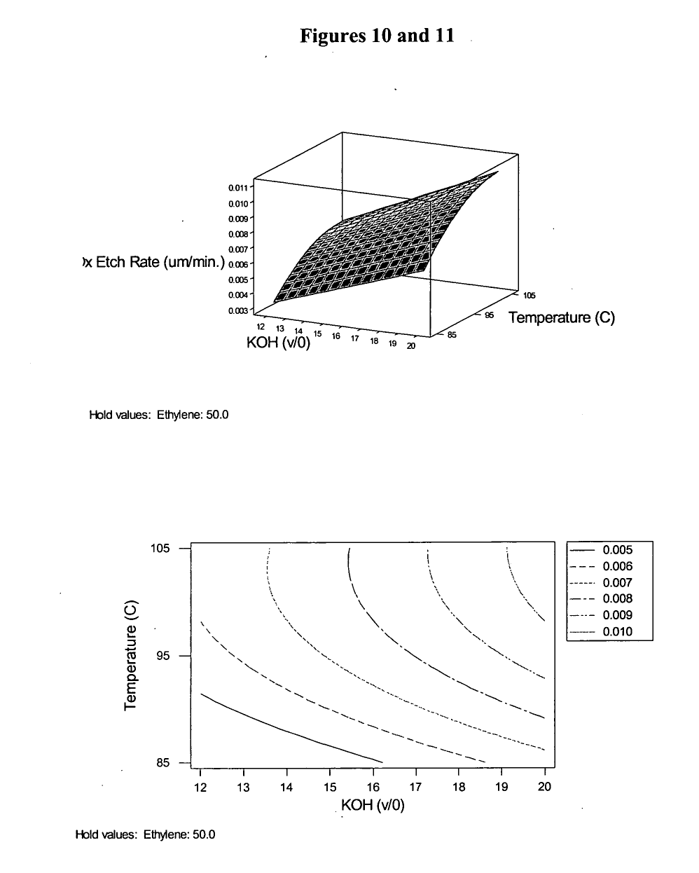

FIGS. 6 and 7 show that the undoped silicon etch rate decreases with increasing KOH concentration and that the etch rate increases with increasing temperature. FIGS. 8 and 9 shows that the CVD oxide etch rate increases with increasing temperature as well as KOH concentration. FIGS. 10 and 11 show that the thermal oxide etch increases with increasing temperature as well as KOH concentration.

P-Plus-T Experiments

DOE studies were conducted to determine etch rates and selectivities as a function of TMAH and additive concentration as well as temperature. Etch rates and etch selectivities of p⁺⁺ doped Si, undoped Si, TOx, and LTO films, as a function of TMAH concentration, ethylene glycol concentration, and temperature were measured employing DOE methods.

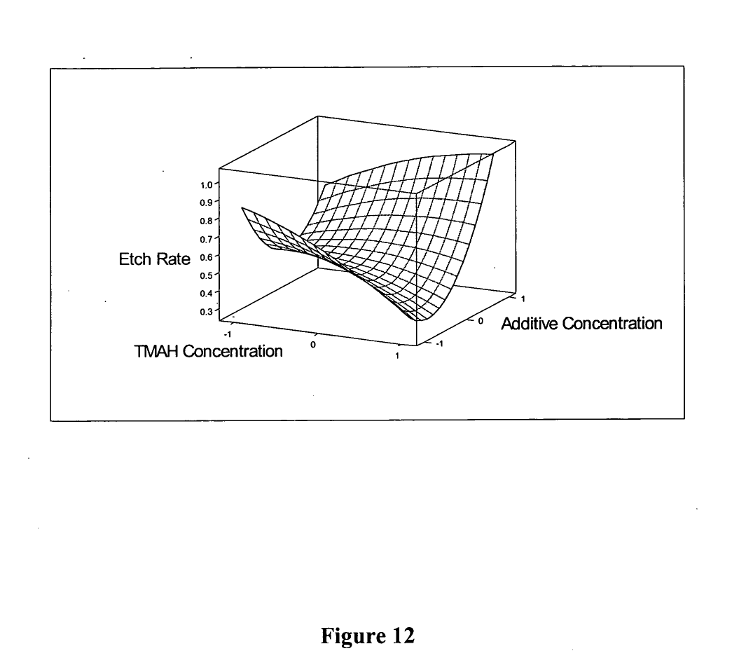

The relative etch rate of undoped silicon as a function of TMAH and additive concentration, presented in FIG. 12, is an example of the DOE results. Metal-free aqueous TMAH etchants are used for processes that require CMOS (complementary metal-oxide semiconductor) compatibility. The addition of ethylene glycol was found to increase that selectivity by a factor of 3 or more. In addition, the etch rates and selectivities of the dielectric films studied were found to be a weak function of the ethylene glycol concentration in the KOH-ethylene glycol-water system as well as the TMAH-ethylene glycol-water system.

Comparison Studies

The following information shows the comparison of conventional EDP etching solutions with replacement etching solutions comprising those solutions described herein and as based on the experiments presented in the Examples section.

| Parameter | EDP | Replacement |
|---|---|---|
| Undoped/Doped Si Selectivity | 900 | 1000 |
| Undoped Si Etch rate (um/min) | 0.9 | 0.8 |
| Undoped Si/CVD Oxide Selectivity | 2800 | 60 |
| Undoped Si/Thermal Oxide Selectivity | 9700 | 180 |
| Undoped Si/Si₃N₄ Selectivity | 14000 | 9000 |
| Temperature (° C.) | 100 | 95 |
| KOH Concentration (v/0) | n/a | 15 |
| Ethylene Glycol Concentration (v/0) | n/a | 37 |

Thus, specific embodiments and applications of selective silicon etching solutions have been disclosed. It should be apparent, however, to those skilled in the art that many more modifications besides those already described are possible without departing from the inventive concepts herein. Moreover, in interpreting the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A selective silicon etchant, comprising:
at least one of potassium hydroxide or tetramethyl ammonium hydroxide,
at least one additive, wherein the additive comprises at least two of the following physical properties: water-soluble, non-volatile and non-flammable, and
an aqueous environment that comprises at least one solvent or solvent blend.

2. The etchant of claim 1, wherein the at least one additive comprises all three of the physical properties.

3. The etchant of claim 1, wherein the potassium hydroxide is present in solution at less than about 30 weight percent.

4. The etchant of claim 3, wherein the potassium hydroxide is present in solution at less than about 20 weight percent.

5. The etchant of claim 4, wherein the potassium hydroxide is present in solution at less than about 10 weight percent.

6. The etchant of claim 1, wherein the at least one additive comprises a glycol-based compound.

7. The etchant of claim 6, wherein the glycol-based compound is ethylene glycol.

8. The etchant of claim 1, where the at least one additive in present in solution at less than about 75 weight percent.

9. The etchant of claim 8, where the at least one additive in present in solution at less than about 60 weight percent.

10. The etchant of claim 9, where the at least one additive in present in solution at less than about 50 weight percent.

11. The etchant of claim 10, where the at least one additive in present in solution at less than about 30 weight percent.

12. The etchant of claim 1, wherein the at least one solvent or solvent blend comprises water.

13. The etchant of claim 1, wherein the etchant comprises a temperature of less than about 125° C.

14. The etchant of claim 13, wherein the etchant comprises a temperature of less than about 105° C.

15. The etchant of claim 14, wherein the etchant comprises a temperature of less than about 95° C.

16. The etchant of claim 15, wherein the etchant comprises a temperature of less than about 85° C.

17. A method of producing a selective silicon etchant, comprising:
providing at least one of potassium hydroxide or tetramethyl ammonium hydroxide;
providing at least one additive, wherein the additive comprises at least two of the following physical properties: water-soluble, non-volatile and non-flammable;
providing an aqueous environment that comprises at least one solvent or solvent blend; and
blending the at least one potassium hydroxide or tetramethyl ammonium hydroxide with the at least one additive in the aqueous environment in order to form a solution that can be utilized as a selective silicon etchant.

18. The method of claim 17, wherein the at least one additive comprises all three of the physical properties.

19. The method of claim 17, wherein the potassium hydroxide is present in solution at less than about 30 weight percent.

20. The method of claim 19, wherein the potassium hydroxide is present in solution at less than about 20 weight percent.

21. The method of claim 20, wherein the potassium hydroxide is present in solution at less than about 10 weight percent.

22. The method of claim 17, wherein the at least one additive comprises a glycol-based compound.

23. The method of claim 22, wherein the glycol-based compound is ethylene glycol.

24. The method of claim 17, where the at least one additive in present in solution at less than about 75 weight percent.

25. The method of claim 24, where the at least one additive in present in solution at less than about 60 weight percent.

26. The method of claim 25, where the at least one additive in present in solution at less than about 50 weight percent.

27. The method of claim 26, where the at least one additive in present in solution at less than about 30 weight percent.

28. The method of claim 17, wherein the at least one solvent or solvent blend comprises water.

29. The method of claim 17, wherein the etchant comprises a temperature of less than about 125° C.

30. The method of claim 29, wherein the etchant comprises a temperature of less than about 105° C.

31. The method of claim 30, wherein the etchant comprises a temperature of less than about 95° C.

32. The method of claim 31, wherein the etchant comprises a temperature of less than about 85° C.
